(19) United States
(12) Patent Application Publication
(10) Pub. No.: US 2025/0035188 A1
(43) Pub. Date: Jan. 30, 2025

(54) LOOP STRING FIXING DEVICE AND METHOD FOR PROVIDING LOOP STRING FIXING DEVICE

(71) Applicant: GD IND Corp., Incheon (KR)

(72) Inventor: Tae Jin An, Incheon (KR)

(73) Assignee: GD IND Corp., Incheon (KR)

(21) Appl. No.: 18/786,091

(22) Filed: Jul. 26, 2024

(30) Foreign Application Priority Data
Jul. 26, 2023 (KR) 10-2023-0097661

(51) Int. Cl. F16G 11/04

(52) U.S. Cl. CPC F16G 11/04

(57) ABSTRACT

According to the present disclosure, a loop string fixing device includes a stopper used for fixing a loop string, the loop string being a string curved at a middle portion to form a loop part and including first and second string extensions extending from the loop part and first and second string end portions at ends of the first and second string extensions, the stopper including a front plate that is formed with first and second through hole rows laterally spaced apart from each other and extending in a height direction, and each of the first and second through hole rows including upper through holes and lower through holes located below the upper through holes.

### CROSS-REFERENCE TO RELATED APPLICATIONS

This application claims the priority of Korean Patent Application No. 10-2023-0097661 filed on Jul. 26, 2023, in the Korean Intellectual Property Office, the disclosure of which is incorporated herein by reference.

### BACKGROUND

The present disclosure relates to a loop string fixing device, and more particularly, to a loop string fixing device including a stopper that fixes a loop string configured so that a string is arranged in a curved form so that a loop is formed at one end and its length can be adjusted while wound around a support body, and a method for providing a loop string fixing device.

### DESCRIPTION OF THE RELATED ART

FIG. 1 is a diagram illustrating a known pull-up handle using a loop string. The pull-up handle is an assistive device used when doing, for example, pull-up exercise, etc. FIG. 2 shows a form in which the pull-up handle is fixed to a straight bar.

The pull-up exercise is an exercise that improves a user's upper body strength. Generally, the pull-up exercise is performed by holding on to a straight bar fixed at a set height and lifting a body weight.

When using a straight bar, an overhand grip that holds the straight bar with the back of the user's hand facing the user and an underhand grip that holds the straight bar with a user's palm facing the user are possible. When performing the pull-up exercise, if a user changes the angle of the grip, a type and location of muscles that are stimulated will change, which may improve the exercise effect, but have the limitations of using the straight bar. The pull-up handle helps a user do the pull-up exercise with various grip positions.

In addition, the straight bar is generally provided in a fixed form at a set height so that it may support the body weight. Therefore, if the position of the straight bar does not match the user's height, it is difficult to perform the pull-up exercise.

In this way, a pull-up handle illustrated in FIG. 1 is used to help a user perform exercises suited to a user's height and muscle strength, and to help perform various exercises that may strengthen muscle strength.

Referring to FIG. 1, a pull-up handle 2 includes a loop string 3 in which a string S is arranged with a loop formed at an end, and a handle 8 for grip in which both ends of the loop string 3 are fixed.

The loop string 3 refers to a string in which a middle portion of a string (cord, rope, string, etc.) extending in a longitudinal direction is arranged in a curved form to form the loop in the middle portion. In this specification, the string forming the loop is referred to as the loop string 3, a part that is located at one end of the loop string 3 and formed with the loop is referred to as a loop part 4, and two end portions of the loop string located on the opposite side of the loop portion 4 are referred to as string end portions 5 and 6.

Referring to FIG. 2, the procedure for fixing the pull-up handle 2 to the straight bar 1 is as follows.

First, the loop part 4 of the loop string 3 is passed over the straight bar 1 so that the loop string 3 is wound around the straight bar 1.

Thereafter, the handle 8 is passed between the loop parts 4 below the straight bar 1 and moved to the opposite side, and then the handle 8 is pulled and tightened to fix the pull-up handle 2 to the straight bar 1.

The form in which the loop string 3 wraps around and fixes to the straight bar 1 is referred to as a lark's head knot or tag knot.

The name tag knot comes from the fact that tags on items are mainly fixed in the form of a knot described above.

For the pull-up exercise, two pull-up handles 2 are fixed to the straight bar 1. The user holds the handle 8 of the pull-up handle 2 with his/her hands and performs exercises such as the pull-up exercise.

The pull-up handle may be used for a variety of exercises, in addition to the pull-up exercise. For example, the user may do an exercise by lifting a weight while fixing the pull-up handle to a ring of the weight. In addition, the user may do an exercise by holding the pull-up handle with both hands with his/her feet touching the ground and pulling up his/her upper body while supporting his/her body at an angle.

In this way, the pull-up handle is not limited to the pull-up exercise, but allows various exercises by fixing the loop string to an object such as the straight bar or weight, and has a function of supporting a load.

This known method using the tag knot is the most common method of fixing the pull-up handle with a known loop string by hanging the pull-up handle on a support body, but may not adjust the height of the handle because the length of the loop string may not be adjusted.

Therefore, when attempting to do an exercise by mounting the pull-up handle on the support body such as the straight bar or the ring at a fixed height, there was a problem in that the loop string should be replaced according to the user's height. In addition, in order to remove the pull-up handle from the support body, there was the inconvenience of having to untie the knotted and tightened loop part and pull the handle back out.

### SUMMARY

An object to be achieved by the present disclosure is to provide a loop string fixing device including a stopper for fixing a loop string whose length is adjustable to a support body such as a straight bar and a ring, and a method for providing a loop string fixing device.

According to an aspect of the present disclosure, a loop string fixing device is used for fixing a loop string, the loop string being a string curved in the middle portion to form a loop part and including first and second string extensions extending from the loop part and first and second string end portions at the ends of the first and second string extensions. The loop string fixing device includes a stopper including a front plate that is formed with first and second through hole rows laterally spaced apart from each other and extending in a height direction, in which each of the first and second through hole rows includes s upper through holes and lower through holes located below the upper through holes.

Each of the first and second through hole rows forms a path through which each of the first and second string extensions extends, the upper through holes form a path through which the first or second string extension passes from a back surface toward a front surface, and the lower through holes form a path through which first or second string extension drawn out to the front surface through the upper through holes passes from the front surface toward the back surface. The loop string is hung over the support body to pull the loop part toward the stopper, then the loop part is arranged to be located between the back surface of the front plate and the first and second string extensions passing through the lower through holes, thereby forming a knot.

According to another aspect of the present disclosure, the stopper includes side plates extending to intersect the front plate in a direction of the back surface of the front plate, and the side plates are formed to guide the loop part to extend along the side plates without being spread.

According to another aspect of the present disclosure, a method for providing a loop string fixing device includes providing a stopper including a front plate that is formed with first and second through hole rows laterally spaced apart from each other and extending in a height direction. Wherein each of the first and second through hole rows includes upper through holes and lower through holes located below the upper through holes. In addition, the method includes providing a loop string, the loop string being a string curved in the middle portion to form a loop part and including first and second string extensions extending from the loop part and first and second string end portions at the ends of the first and second string extensions, and providing a loop string fixing device by assembling the loop string and the stopper so that each of the first and second string extensions passes through the corresponding upper through holes from a back surface toward a front surface and each of the first and second string extensions drawn out to the front surface through the upper through holes passes from the front surface toward the back surface through the corresponding lower through holes.

According to another aspect of the present disclosure, in the loop string fixing device, the loop string is hung over the support body to pull the loop part toward the stopper, and may form a knot in such a way that the loop part is arranged to be located between the back surface of the front plate and the first and second string extensions passing through the lower through holes.

According to another aspect of the present disclosure, the stopper includes side plates extending to intersect the front plate in a direction of the back surface of the front plate, and the side plates are formed so that the loop part extends along the side plates without being spread.

According to the present disclosure, the loop string can be fixed to the support body such as the straight bar and the ring in an adjustable length manner.

### BRIEF DESCRIPTION OF THE DRAWINGS

The above and other aspects, features and other advantages of the present disclosure will be more clearly understood from the following detailed description taken in conjunction with the accompanying drawings, in which:

FIG. 1 is a diagram illustrating a known pull-up handle using a loop string;

FIG. 2 is a diagram illustrating a form in which the known pull-up handle is fixed to a straight bar;

FIGS. 3 and 4 are perspective views of a stopper forming a loop string fixing device according to an exemplary embodiment of the present disclosure, as viewed from the front and rear directions;

FIG. 5 is a diagram illustrating a form in which first and second string extensions are assembled to the stopper in the loop string fixing device according to an exemplary embodiment of the present disclosure;

FIGS. 6 and 7 are diagrams for describing a form in which a loop part is fixed by forming a knot with the first and second string extensions through the stopper in a state in which the loop string in the loop string fixing device according to an exemplary embodiment of the present disclosure is wound around the straight bar;

FIG. 8 is a diagram for describing that a length of the loop string is adjusted in the loop string fixing device according to the present disclosure; and

FIG. 9 is a diagram illustrating an exemplary embodiment in which the loop string fixing device according to an exemplary embodiment of the present disclosure is implemented as a swing.

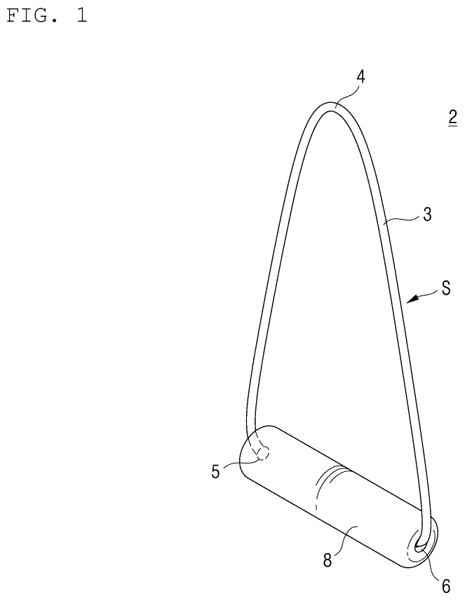

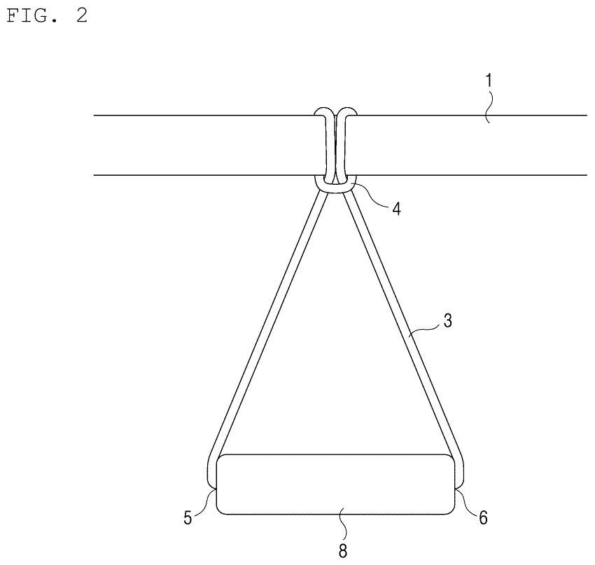

### DETAILED DESCRIPTION

Hereinafter, exemplary embodiments of the present disclosure will be described in detail with reference to the accompanying drawings.

The present disclosure may be variously modified and have several forms. Therefore, specific exemplary embodiments of the present disclosure will be described in detail in the present specification. However, it is to be understood that the present disclosure is not limited to a specific embodiment, but includes all modifications, equivalents, and substitutions included in the scope and spirit of the present disclosure. In describing each drawing, similar reference numerals are used for similar components.

The terms are used only to distinguish one component from another component. Terms used in the present application are used only in order to describe specific exemplary embodiments rather than limiting the present disclosure. Singular forms are intended to include plural forms unless the context clearly indicates otherwise.

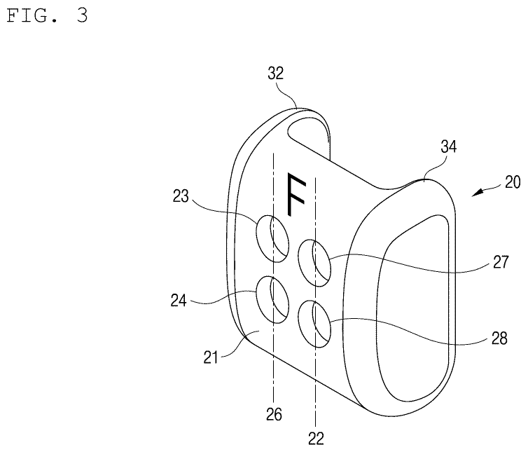

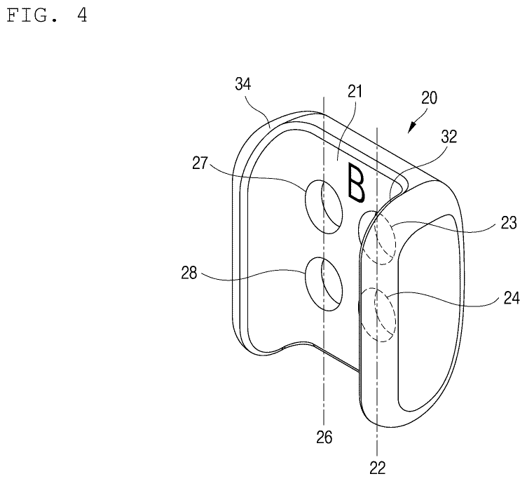

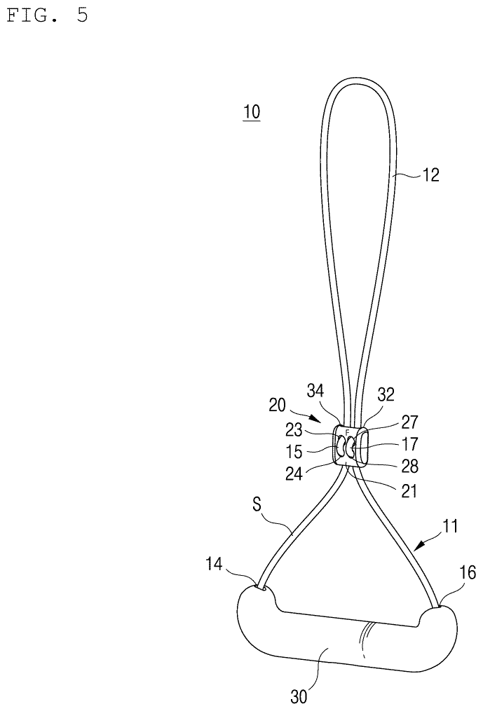

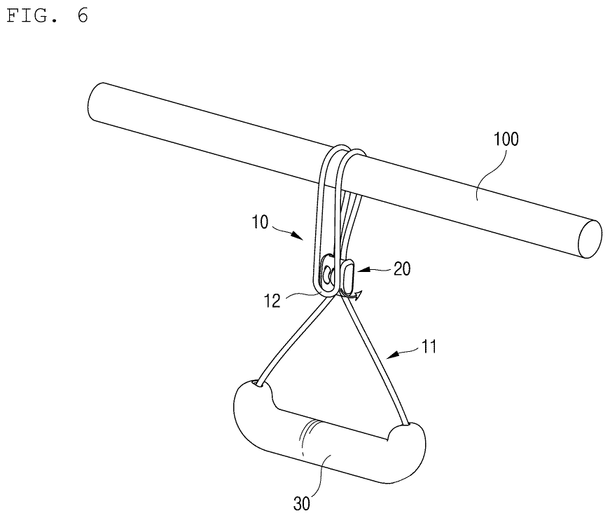

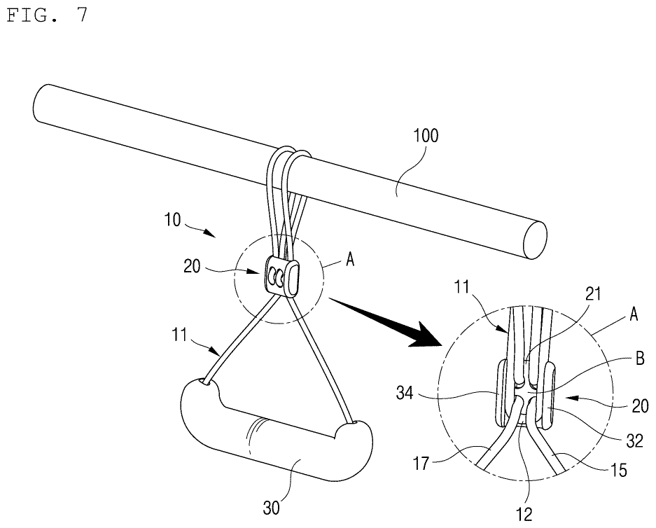

FIGS. 3 and 4 are perspective views of a stopper forming a loop string fixing device according to an exemplary embodiment of the present disclosure, as viewed from the front and rear directions, FIG. 5 is a diagram illustrating a form in which first and second string extensions are assembled to the stopper in the loop string fixing device according to an exemplary embodiment of the present disclosure, and FIGS. 6 and 7 are diagrams for describing a form in which a loop part is fixed by forming a knot with the first and second string extensions through the stopper in a state in which the loop string in the loop string fixing device according to an exemplary embodiment of the present disclosure is wound around the straight bar.

A loop string fixing device (10) according to the present disclosure includes a stopper (20) for fixing a loop string, and the stopper (20) is used to fix the loop string (11) whose length is adjustable.

The loop string (11) is arranged to form a loop part (12) by making a middle portion of a string S extending in a longitudinal direction in a curved form, and the string S extending to both prongs of the loop part (12) is referred to as first and second string extensions (15 and 17), and ends of the first and second string extensions (15) and (17) opposite to the loop part (12) are referred to as the first and second string end portions 14 and 16.

Referring to FIGS. 3 and 4, the stopper (20) for fixing the loop string according to an exemplary embodiment of the present disclosure includes a front plate (21) in which a through hole is formed. In addition, the stopper (20) includes side plates (32) and (34) extending to intersect the front plate (21) in the direction of the back surface of the front plate (21).

The front plate (21) includes two through hole rows (22) and (26), and each through hole row (22) or (26) includes two through holes (23), (24), (27), and (28). The through holes (23), (24), (27), and (28) may be formed in a circular hole.

Each of the through hole rows (22) and (26) of the front plate (21) forms a path through which the first and second string extensions (15) and (17) pass.

The side plates (32) and (34) extend toward a back surface of the front plate (21) to intersect with respect to the front plate (21). The side plates (32) and (34) function to maintain the loop part (12), which forms a knot with the first and second string extensions (15) and (17), on the back surface of the front plate (21). In this way, the loop part (12) maintains contact with the first and second string extensions (15) and (17) without being spread. When tension is applied in this contact state, tightening occurs that binds the string extension and the loop part together by friction force. This tightening causes conditions such as jamming, so a connection between the loop part and each string extension forms a knot that resists the pulling force at the string end portion.

The assembly relationship between the loop string and the stopper in the loop string fixing device will be described with reference to FIG. 5.

The first and second string extensions (15) and (17) branch on both sides of the loop part 12 and extend toward the first and second string end portions (14) and (16), respectively.

The first string extension (15) extends through the first through hole row (22) of the stopper (20). The first string extension (15) extending toward the first string end portion (14) extends to a back surface B of the front plate (21) and is inserted into the upper through hole (23) of the first through hole row (22) to be drawn out to a front surface F of the front plate (21). Then, the first string extension 15 is inserted into the lower through hole (24) on the front surface F and is drawn out and extended to the back surface B of the front plate (21).

The second string extension (17) extends through the second through hole row (26). The second string extension (17) extending toward the second string end portion (16) extends to the back surface B of the front plate (21) and is inserted into the upper through hole (27) of the second through hole row (26) to be drawn out to a front surface F of the front plate (21). Thereafter, the second string extension (17) is inserted into the lower through hole (28) and extends downward toward the back surface B of the front plate (21).

The position of the stopper (20) may be adjusted by moving the position of the stopper (20) along the loop string (11). Since the loop part (12) of the loop string (11) is fixed to the stopper (20 in the loop string fixing device (10), the position of the stopper (20) with respect to the loop string (11) is adjusted by adjusting the length of the loop string (11) wound around the support body.

A form in which the position of the loop string is fixed in the loop string fixing device by forming the knot via the stopper will be described with reference to FIGS. 6 and 7.

Referring to FIG. 6, the direction of the loop string (11) changes while the loop string (11) is hung over the support body (100), such as the straight bar, the loop part (12) is pulled to the position of the stopper (20), the loop part (12) passes to the back surface B of the stopper (20), and then the loop string (11) is pulled.

Referring to FIG. 7, as shown in enlarged portion A, the loop part (12) is located between the first and second string extensions (15) and (17) that are drawn out through the back surface B of the stopper (20 and the lower through holes (24) and (28) and extend downward. In this case, the tightening to fix the loop part (12) occurs while the downward tension acting on the first and second string extensions (15) and (17) and the upward tension acting on the loop part (12) are applied. In this specification, fixing the string as described above through the stopper (20) is referred to as forming the knot. The knot illustrated in FIG. 7 is similar to the principle of forming the tag knot.

The side plates (32) and (34) are positioned so that when the tension is applied to the loop string (11), the first and second string extensions (15) and (17) and the loop part (12) form the tightened state. As a result, the loop part (12) is not spread by the side plates (32) and (34) and extends upward along the back surface B of the stopper (20) while pressing the first and second string extensions (15) and (17).

Referring to FIG. 7, it can be seen that the strings on both sides of the loop part 12) are pressed in the direction of the side plates (32) and (34) by the strings that pass through the through holes (23), (24), (27), and (28). When there is no side plate (32) or (34), the loop part (12) may contact the first and second string extensions (15) and (17) that pass through the lower through holes (24) and (28) on the lower side of the lower through holes (24) and (28) and then spread. In this case, the fixing force that forms the knot may be weakened. However, when the loop part (12) extends from the back surface B of the stopper (20) while contacting the first and second string extensions (15) and (17) by the side plates (32) and (34), the knot fixes the strings strongly while the jamming between strings occurs.

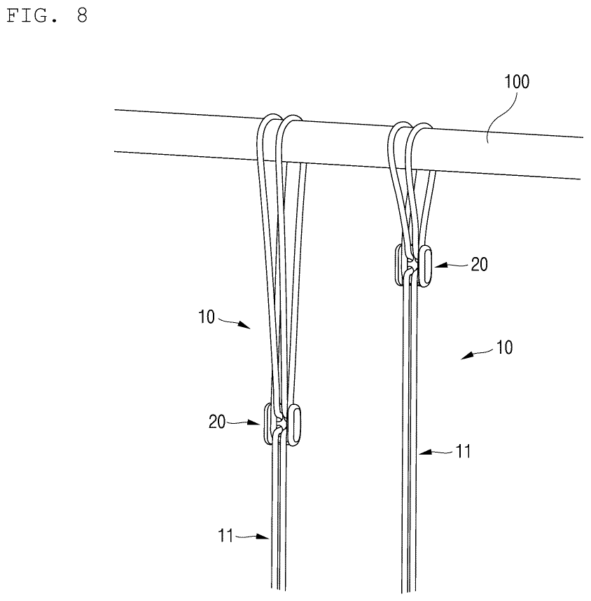

FIG. 8 is a diagram for describing that a length of the loop string is adjusted in the loop string fixing device according to the present disclosure. As the position of the stopper (20) is adjusted in the loop string fixing device, the length of the loop string (11) located between the support body (100 and the stopper (20) changes. Since the loop string (11) overlaps between the support body (100) and the stopper (20), when the position of the stopper changes, the position of the string end portion with respect to the support body (100) is adjusted. Since the position of the string end portion with respect to the support body (100) corresponds to the length of the loop string fixed to the support body, the length of the loop string may be adjusted.

Referring back to FIGS. 6 and 7, FIGS. 6 and 7 illustrate an exemplary embodiment in which the loop string fixing device according to an exemplary embodiment of the present disclosure is implemented as the pull-up handle.

As illustrated in FIGS. 6 and 7, the first and second string end portions (14) and (16) are fixed to the bar (30), and the fixed position of the loop part (12) changes as the position of the stopper (20) changes. As a result, it is possible to change the position of the bar (30) with respect to the support body (100), that is, the height with respect to the ground.

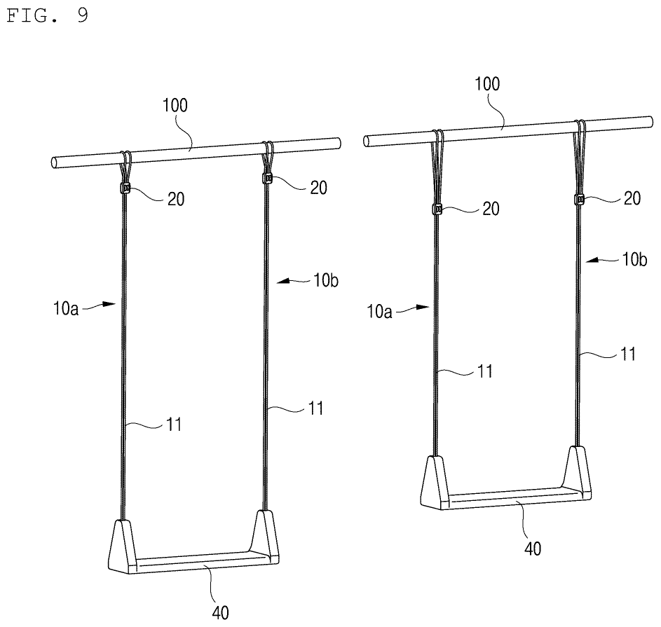

FIG. 9 is a diagram illustrating an exemplary embodiment in which the loop string fixing device according to an exemplary embodiment of the present disclosure is implemented as a swing.

Referring to FIG. 9, two loop string fixing devices (10a) and (10b) are provided, and each loop string fixing device (10a) or (10b) is coupled to a side surface of a sheet (40). Both string end portions of one loop string fixing device (10a) are coupled to one side surface of the sheet (40), and both string end portions of the other loop string fixing device (10b) are coupled to the other side surface of the sheet (40).

The height of the sheet (40) with respect to the support body (100) is adjusted by adjusting the overlapping length of the loop string (11) in each loop string fixing device (10a) or (10b). FIG. 9 illustrates two swings arranged at different heights. In this way, by using the loop string fixing device, it is possible to adjust a height of an object supported by the loop string fixing device, in FIG. 9, the sheet, with respect to the support body.

As another exemplary embodiment of the present disclosure, in the loop string fixing device, both string end portions may be coupled to each other. This exemplary embodiment is another example of implementing a pull-up assistive device using a loop string fixing device. The string has sufficient elasticity, and a user may step on the loop string located at the bottom and do the pull-up exercise with the help of the elastic string. The user may adjust the length of the loop string to suit the straight bar and key.

Although the present disclosure has been described in detail through the representative exemplary embodiment above, the scope of the present disclosure is not limited to the description and expression of the exemplary embodiments described above. The scope of rights of the present disclosure cannot be limited due to changes or substitutions that are obvious in the technical field to which the present disclosure pertains, and the scope of rights of the present disclosure is determined not only by the claims described below but also by equivalents to these claims.

What is claimed is:

1. A loop string fixing device comprising a stopper used for fixing a loop string,
wherein the loop string is a string curved at a middle portion to form a loop part and includes first and second string extensions extending from the loop part and first and second string end portions at ends of the first and second string extensions,
wherein the stopper includes a front plate that is formed with first and second through hole rows laterally spaced apart from each other and extending in a height direction, and
wherein each of the first and second through hole rows includes upper through holes and lower through holes located below the upper through holes.

2. The loop string fixing device of claim 1, wherein each of the first and second through hole rows forms a path through which each of the first and second string extensions extends,
the upper through holes form a path through which the first or second string extension passes from a back surface (B) of the front plate toward a front surface (F), and
the lower through holes form a path through which the first or second string extension drawn out to the front surface (F) through the upper through holes passes from the front surface (F) toward the back surface (B), and
wherein the loop string fixing device is used in such a way that the loop string is hung over a support body to pull the loop part toward the stopper and the loop part is arranged to be located between the back surface (B) of the front plate and the first and second string extensions passing through the lower through holes.

3. The loop string fixing device of claim 1, wherein the stopper includes side plates extending to intersect the front plate in a direction of the back surface (B) of the front plate, and
the side plates are formed so that the loop part extends along the side plates without being spread.

4. A method for providing a loop string fixing device, comprising:
providing a stopper including a front plate that is formed with first and second through hole rows laterally spaced apart from each other and extending in a height direction, in which each of the first and second through hole rows includes upper through holes and lower through holes located below the upper through holes;
providing a loop string, the loop string being a string curved at a middle portion to form a loop part and including first and second string extensions extending from the loop part and first and second string end portions at ends of the first and second string extensions;
providing a loop string fixing device by assembling the loop string and the stopper so that each of the first and second string extensions passes through the corresponding upper through holes from a back surface (B) toward a front surface (F) and each of the first and second string extensions drawn out to the front surface (B) through the upper through holes passes from the front surface (F) toward the back surface (B) through the corresponding lower through holes.

5. The method of claim 4, wherein, in the loop string fixing device, the loop string is hung over the support body to pull the loop part toward the stopper, and is used in a way to form a knot so that the loop part is arranged to be located between the back surface (B) of the front plate and the first and second string extensions passing through the lower through holes.

6. The method of claim 5, wherein:
the stopper includes side plates extending to intersect the front plate in a direction of the back surface (B) of the front plate, and
the side plates are formed so that the loop part extends along the side plates without being spread.
